(19) United States
(12) Patent Application Publication
(10) Pub. No.: US 2020/0230928 A1
(43) Pub. Date: Jul. 23, 2020

(54) FLEXIBLE FILMS, BAGS THEREFROM, AND PRODUCTS THEREIN WITH EXTENDED SHELF LIFE

(71) Applicant: Liqui-Box Corporation, Richmond, VA (US)

(72) Inventor: Adrian Ellis Jackson, Folsom, CA (US)

(21) Appl. No.: 16/749,207

(22) Filed: Jan. 22, 2020

Related U.S. Application Data
(60) Provisional application No. 62/795,190, filed on Jan. 22, 2019.

(51) Int. Cl. B32B 27/08; B32B 27/32; B32B 27/36; B32B 27/30; B65D 65/40; B65D 85/72; B32B 7/12; C12G 1/00; C12C 11/00

(52) U.S. Cl. CPC B32B 27/08; B32B 27/32; B32B 27/36; B32B 27/306; B65D 65/40; B65D 85/72; B32B 2307/724; C12G 1/00; C12C 11/00; B32B 2439/70; B32B 2439/46; B32B 2250/24; B32B 7/12

(57) ABSTRACT

This invention relates to flexible polymeric films, pouches or bags made from such flexible films, and such pouches comprising products therein. The flexible films and the pouches of the present invention, surprisingly, manifest not only high flex-crack resistance, but also a reduced oxygen transmission rate, even when exposed to varying levels of relative humidity, including relative humidity above 90%. Furthermore, this invention also relates to pouches comprising products that have improved shelf life owing to a minimal penetration of oxygen while having been exposed to high humidity.

### CROSS REFERENCE TO RELATED APPLICATIONS

This application claims the benefit of U.S. Provisional Application No. 62/795,190, filed Jan. 22, 2019, the entirety of which is incorporated herein for any and all purposes

### TECHNICAL FIELD

This invention relates to flexible polymeric films, pouches or bags made from such flexible films, and such bags comprising products therein. The flexible films and the pouches of the present invention, surprisingly, manifest not only high flex-crack resistance, but also a reduced oxygen transmission rate, even when exposed to varying levels of relative humidity, including relative humidity above 90%. Furthermore, this invention also relates to pouches comprising products that have improved shelf life owing to a minimal penetration of oxygen while having been exposed to high humidity.

### BACKGROUND

Generally, flexible bags or pouches are made from laminate films and filled with flowable materials. Laminate films, generally comprising polyolefins, for packaging flowable materials, are described in U.S. Pat. Nos. 4,503,102; 4,521,437; 5,206,075; 5,364,486; 5,508,051; 5,721,025; 5,879,768; 5,942,579; 5,972,443; 6,117,4656; 6256,966; 6,406,765; 6,416,833; and 6,767,599. These patents describe polymer blends to manufacture flexible packages for packaging flowable materials, which includes food packaging. These patents are incorporated herein by reference.

Flexible packaging, particularly for food, is subject to many demands. The packaging needs to be workable in such a way that the packaging material may be quickly placed around the item to be packaged using machinery. The packaging material must also be of such a quality that it adequately stores the product before the packaging is open. In the case of food products, this typically means that the packaging materials provide an oxygen barrier to maintain freshness.

Flexible bags for packaging flowable materials can suffer from two problems, inter alia: (1) poor flex-crack resistance, and (2) high oxygen transmission rate. However, improving flex-crack resistance (FCR) and reducing OTR, the two desirable properties, work against each other. Stated differently, changing the resin blend composition to improve the FCR will undesirably increase the OTR, and vice versa.

An increased relative humidity—especially above 90%—further exacerbates these problems. In other words, flexible bags comprising products provide limited shelf life because high relative humidity increases oxygen transmission rate (OTR), and in turn, overall oxygen transmission, into the product packaged within the bags.

### Improving Flex-Crack Resistance of Flexible Film

Flex-crack resistance is extremely important for flexible bags used to package flowable materials, particularly liquids, and most particularly for lower viscosity liquids like alcoholic beverages, water, milk, juices, concentrates, purees and the like. These liquids can slosh around considerably during handling, transportation, and distribution of filled packages, causing flexing of the inner-ply film and flex-cracking of film materials.

Liquid movement within the bulk-bag causes flex-cracking. Flex-cracking most likely occurs in the film portion that is near the liquid line. Flex-crack pinholes result at least in loss of oxygen and moisture barrier, reducing the shelf life potential of the packaged product, and in more extreme cases, loss of the hermetic seal, rendering the product unsafe for consumption.

Superior flex-crack resistance is needed to prevent the formation of “crocodile-skin” on the flexible bag. “Crocodile-skin” can form when superheated steam injected into the bag, for example, during the aseptic filling process, partially sticks the polyethylene inner-ply to the outer-ply. As the bag cools, the inner-ply and the outer-ply may shrink at different rates, causing wrinkling. The sticking of the outer to the inner-plies also makes the bag stiffer, increasing flex-cracking during handling, shipping, and distribution.

### Reducing Oxygen Transmission Rate of Flexible Film

A reduced OTR is desired in flexible bags for packaging products, especially liquid products. For example, in aseptic packaging, in aseptic steam sterilization is used prior to filling the bags. Bags after steam sterilization show increased oxygen transmission rate. Similarly, the relative humidity varies during handling, transportation, storage, distribution, and shelving of packaged products. Products that are sensitive to contamination of the product itself or its taste or smell decrease their shelf lives rather rapidly upon exposure to high moisture or relative humidity, which results into an incremental oxygen ingress into the product.

The present invention concomitantly addresses the above two problems, namely: lack of flex-crack resistance, and high oxygen transmission rate, both under high relative humidity exposure. With the intent of being able to store wine or spirits in a flexible packaging format for a longer time currently prescribed by the market, 9-12 months, there needed to be a way of reducing the oxygen ingress through the packaging after the filling process has taken place. There needed to be a way of reducing the effects of dissolved oxygen in the wine, during normal transport, distribution, storage, and display of the product in the flexible bags. With current available material structures being exposed to a varying relative humidity during transport, distribution, storage and display, the effect of the OTR rate of the current packaging materials available in this segment are compromised.

### BRIEF DESCRIPTION OF DRAWINGS

FIG. 1 depicts the general construction of a flexible bag wall of invention for improved properties at very high Relative Humidity %;

FIG. 2 depicts the Met-Flex film manufactured with thermally-laminated three layers;

FIG. 3 depicts the Met-Flex Film manufactured using extrusion lamination/coating process;

FIG. 4 depicts the Met-Flex film manufactured using extrusion lamination with co-extrusion multi-layer technology;

FIG. 5 depicts the Met-Flex film manufactured using extrusion lamination with thermal lamination;

FIG. 6 depitcs the Met-Flex film manufactured using adhesive lamination;

FIG. 7A depicts oxygen transmission rate (OTR) as a function of Relative Humidity for commercially available film samples;

FIG. 7B depicts OTR as a function of Relative Humidity for commercial film samples and invention film sample; and

FIG. 8 depicts a film structure of the present invention.

### SUMMARY OF THE INVENTION

In one embodiment, this invention relates to polymeric film for preparing flexible bags, comprising the following layers:
(A) a sealant layer, wherein said sealant layer comprises LLDPE;
(B) an OTR-reducing barrier layer, wherein said OTR-reducing barrier layer comprises metallized PET or metallized BoPA; and
(C) an FCR-improving layer, wherein said FCR-improving layer comprises EVOH co-ex;
wherein said polymeric film demonstrates an oxygen transmission rate (OTR) not greater than 1 cm³/m²-day after 50 cycles of Gelbo Flex test.

In another embodiment, this invention relates to the polymeric film described above, wherein said flexible bag demonstrates an oxygen transmission rate (OTR) not greater than 1.5 cm³/m²-day after 100 cycles of Gelbo Flex test.

In one embodiment, this invention relates to the polymeric film described above, wherein said sealant layer, said OTR-reducing barrier layer, and said FCR-improving layer each have a thickness in the range of from about 25 microns to 100 microns.

In another embodiment, this invention relates to the polymeric film described above, made using at least one of the following processes: extrusion lamination, thermal lamination, with-solvent adhesion, solventless adhesion, coating, and co-extrusion multi-layer technology.

In yet another embodiment, this invention relates to a flexible bag prepared from a polymeric film, wherein said polymeric film comprises the following layers:
(A) a sealant layer, wherein said sealant layer comprises LLDPE;
(B) an OTR-reducing barrier layer, wherein said OTR-reducing barrier layer comprises metallized PET or metallized BoPA; and
(C) an FCR-improving layer, wherein said FCR-improving layer comprises EVOH co-ex;
wherein said polymeric film demonstrates an oxygen transmission rate (OTR) not greater than 1 cm³/m²-day after 50 cycles of Gelbo Flex test.

In one embodiment, this invention relates to a flexible bag described above, wherein said flexible bag demonstrates an oxygen transmission rate (OTR) not greater than 1.5 cm³/m²-day after 100 cycles of Gelbo Flex test.

In another embodiment, this invention relates to a flexible bag described above, wherein said sealant layer, said OTR-reducing barrier layer, and said FCR-improving layer each have a thickness in the range of from about 25 microns to 100 microns.

In yet another embodiment, this invention relates to a flexible bag described above, made using at least one of the following processes: extrusion lamination, thermal lamination, with-solvent adhesion, solventless adhesion, coating, and co-extrusion multi-layer technology.

In one embodiment, this invention relates to a flexible bag described above, wherein said bag has a capacity from about 1 L to 400 gallons.

In another embodiment, this invention relates to a packaged flexible bag, comprising one of the following products:
(A) wine, (B) beer, (C) water, (D) milk, (E) a non-alcoholic beverage, (F) an alcoholic beverage not including wine or beer, (G) aerated water, (H) an energy drink, (I) fruit juice, (J) vegetable juice, (K) chemical, and (L) detergent; (M) juice not including fruit juice; (N) sauces; (0) mustard; (P) ketchup; (Q) food dressings; (R) cheese; (S) sour-cream; (T) mayonnaise; (U) salad dressings; (V) relish; (W) oil; (X) margarine; (Y) coffee concentrate; (Z) pastes; (Z1) puree; (Z2) ice cream mix (Z3) milk shake mix; (Z4) preserves; (Z5) emulsions; (Z6) doughnut fillings; (Z7) jellies; (Z8) caulking material; (Z9) medicine; and (Z10) materials used in manufacturing;
wherein, said flexible bag demonstrates an oxygen transmission rate (OTR) not greater than 0.6 cm³/m²-day.

In yet another embodiment, this invention relates to a packaged flexible bag described above, wherein said flexible bag is exposed to a relative humidity of at least 75% RH.

In one embodiment, this invention relates to a packaged flexible bag described above, wherein said relative humidity is selected from at least 75% RH, at least 80% RH, at least 85% RH, at least 95% RH, and at least 95% RH.

In another embodiment, this invention relates to a packaged flexible bag described above, wherein said flexible bag demonstrates an oxygen transmission rate (OTR) not greater than 1 cm³/m²-day after 50 cycles of Gelbo Flex test.

In yet another embodiment, this invention relates to a packaged flexible bag described above, wherein said flexible bag demonstrates an oxygen transmission rate (OTR) not greater than 1.5 cm³/m²-day after 100 cycles of Gelbo Flex test.

In one embodiment, this invention relates to a packaged flexible bag described above, wherein said product is wine.

In another embodiment, this invention relates to a packaged flexible bag described above, wherein said product is beer.

In yet another embodiment, this invention relates to a packaged flexible bag described above, wherein said product is water.

In one embodiment, this invention relates to a packaged flexible bag described above, wherein the film of said flexible bag comprises the following layers:
(A) a sealant layer, wherein said sealant layer comprises LLDPE;
(B) an OTR-reducing barrier layer, wherein said OTR-reducing barrier layer comprises metallized PET or metallized BoPA; and
(C) an FCR-improving layer, wherein said FCR-improving layer comprises EVOH co-ex.

In another embodiment, this invention relates to a packaged flexible bag described above, wherein said sealant layer, said OTR-reducing barrier layer, and said FCR-improving layer each have a thickness in the range of from about 25 microns to 100 microns.

In yet another embodiment, this invention relates to a packaged flexible bag described above, wherein said film for said flexible bag is made using at least one of the following processes: extrusion lamination, thermal lamination, with-solvent adhesion, solventless adhesion, coating, and co-extrusion multi-layer technology.

In one embodiment, this invention relates to a packaged flexible bag described above, wherein said bag has a capacity from about 1 L to 400 gallons.

### DETAILED DESCRIPTION OF THE INVENTION

By “FCR” is meant flex-crack resistance.

By “OTR” is meant oxygen-transmission rate.

The terms “flexible bags,” bags, and “pouches” are used interchangeably.

By “flowable materials” is meant materials which are flowable under gravity or which may be pumped. Normally such materials are not gaseous. Food products or ingredients in liquid, powder, paste, oils, granular or the like forms, of varying viscosity are envisaged. Materials used in manufacturing and medicine are also considered to fall within such materials.

The flexible film and bags of the present invention are very suitable for the following beverages: wine; beer; water; aerated water; soda; non-alcoholic wine coolers; energy drinks; fruit juices; vegetable juices; chemical and detergents. Chemicals also include oils, preferably the ones that are hygroscopic. For example, motor oils, lubricants, brake fluids, and hydraulic fluids. Other examples of chemicals include glycerol, ethanol, methanol, sulfuric acid, fertilizer chemicals, and salts.

These liquid products packaged in flexible bags lose their character, for example, in terms of their taste or fragrance owing to the increase in dissolved oxygen into the product. The oxygen enters the products from the outside atmosphere, by penetrating through the flexible bag. The OTR problem is exacerbated when the bags packaged with products are exposed to high relative humidity environment.

The present invention relates to flexible films, flexible bags, and packaged bags with products that have improved flex-crack resistance, reduced OTR, and high tolerance to high humidity as measured by its OTR.

### Flexible Bag Construction

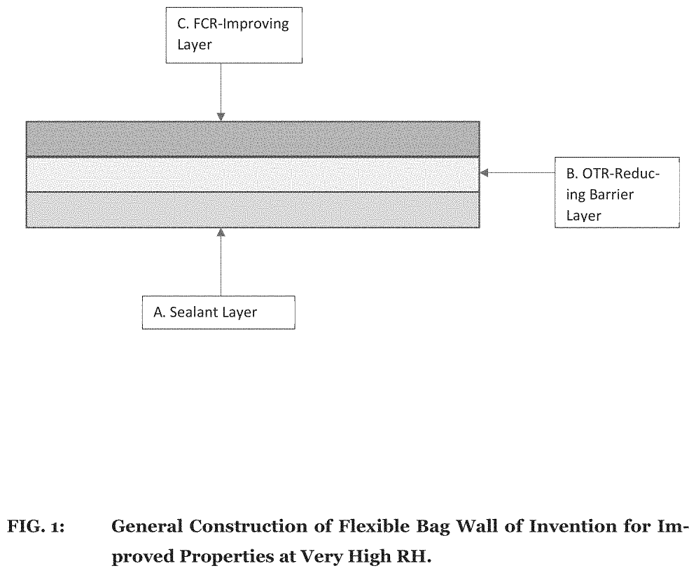

FIG. 1 shows a typical construction of the flexible bag of the present invention. The wall of said flexible bag made from a laminate of flexible materials comprises the following layers:

(A) an FCR-improving layer; (B) an OTR-reducing barrier layer; and (C) a sealant layer.

Generally, the sealant layer is on the outside and further away from the product to be packaged in the flexible bag. The FCR-improving layer is on the inside and proximate to the ingredient to be packaged in the flexible bag. The OTR-reducing barrier layer is in between the sealant layer and the FCR-improving layer. Other polymeric layers with other functionalities may be interposed in between the FCR-improving layer and the OTR-reducing barrier layer, and/or in between the OTR-reducing layer and the sealant layer.

The resin composition can form one or more layers of a multilayer coextruded film made in a blowing or casting process. Films of the resin composition can also be combined with other layers in processes such as adhesive lamination, thermal lamination, extrusion lamination, extrusion coating and the like.

### A. FCR-Improving Layer

In one embodiment, this layer comprises coextruded EVOH (EVOH co-ex) blown film. EVOH co-ex holds its oxygen barrier properties (OTR) very well when subjected to flex cracking, or continuous bending. However, co-ex EVOH does not perform well as an oxygen barrier during varying levels of humidity. Flex-cracking would typically occur during the bag manufacture process and can also be experienced during transportation of the filled bags.

The EVOH co-ex comprises 3, 5, 7, 9, 11, 12, or 13 layers or even an asymmetric distribution of co-extruded layers.

An example of EVOH coextrusion is a ply or layer comprising polyethylene/tie layer/ethylene vinyl alcohol/tie layer/polyethylene.

Ethylene vinyl alcohol (EVOH) is an extrudable resin that has excellent oxygen, flavor, and aroma barrier properties. EVOH resins and packaging materials have been used for several decades as meat and cheese film wrappers and the barrier properties of EVOH with respect to oxygen, grease, oil, flavor additives, and aroma is well understood.

However, when exposed to humidity levels of 85% or higher, the barrier properties of EVOH degrade. To avoid the degradation, the EVOH is typically extruded in a multi-layer symmetrical coextrusion in which specialized tie resins are used to adhere the EVOH to outer polyolefin layers that protect the EVOH from humidity. For example, in the present invention, a three resin, five-layer coextrusion of EVOH may include LDPE-Tie layer-EVOH-Tie layer-LDPE. In this five-layer structure, the LDPE (low density polyethylene) layers protect the EVOH layer from exposure to moisture. Also, the LDPE and tie-layer are extruded each from one extruder where they are split into two layers and directed to either side of the EVOH layer by a feed-block device. The LDPE and Tie layer are the same material on both sides of the EVOH, thus it is called a symmetrical coextrusion. But even with the multilayer construction, under high relative humidity, for example 90% or 95% or greater, EVOH degrades.

The thickness of the FCR layer is in the range of 25 μm to 100 μm. Stated differently, the thickness of the FCR layer can be any number from the following number in μm:
25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The thickness of the FCR layer can be in the range defined by any two numbers selected from the numbers delineated above, including the end-points of such range.

### B. OTR-Reducing Barrier Layer

The polymeric materials contemplated as the OTR-reducing barrier layer include any polymeric film oriented or unoriented which includes polymeric or copolymeric PET or PA. PET is polyethylene terephthalate and PA is polyamide or Nylon. The polymeric film is metallized, for example, metallized, PET or metallized PA.

In some embodiments, such films are made from polypropylene or PLA (polylactic acid) or PVOH.

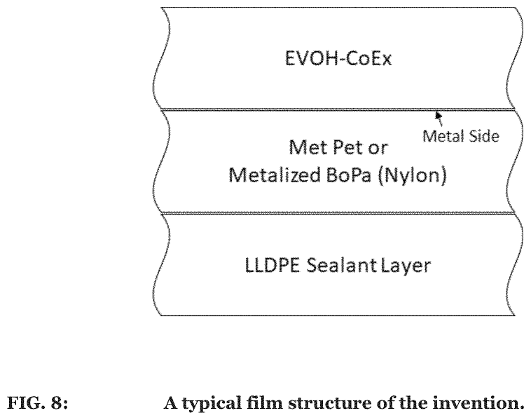

In one embodiment, this layer comprises metallized polyester (Met-PET) or metallized bi-axially oriented polyamide layer (Met-BoPA) (See FIG. 8). Depending on the grades chosen, one can get very good barrier that is not affected by changes in relative humidity. However, the oxygen barrier properties do not stand up very well to flex cracking. By combining both the EVOH for its great flex durability and Met-PET or Met-BoPA, for their resistance against varying relative humidity, one can capitalize on both benefits and create a barrier film that allows for the oxygen barrier properties to be affected minimally during normal application.

During high and varying relative humidity, the oxygen barrier properties of the EVOH co-ex may be compromised. Traces of oxygen will pass through the EVOH co-ex, but will “bounce off” the metallized layer on the PET or BoPA. The metallized layer will act as the OTR barrier in this high relative-humidity application.

During high levels of flex cracking, the metallized layer could be compromised and the EVOH co-ex protects the construction from oxygen ingress.

By engineering a laminated structure that is not affected by relative humidity, one can control and closely predict the amount of oxygen that passes through the packaging material.

The thickness of the OTR layer is in the range of 25 μm to 100 μm. Stated differently, the thickness of the OTR layer can be any number from the following number in μm:
25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The thickness of the OTR layer can be in the range defined by any two numbers selected from the numbers delineated above, including the end-points of such range.

The film construction of the present invention provides an oxygen transmission rate less than 2 cm³/m²-day. Some embodiments provide an OTR that is less than the following numbers measured in cm³/m²-day:
2, 1.95, 1.9, 1.85, 1.80, 1.75, 1.70, 1.65, 1.60, 1.55, 1.50, 1.45, 1.40, 1.35, 1.30, 1.25, 1.20, 1.15, 1.10, 1.05, 1.00, 0.95, 0.90, 0.85, 0.80, 0.75, 0.70, 0.65, 0.60, 0.55, 0.50, 0.45, 0.40, 0.35, 0.30, 0.25, 0.20, 0.15, 0.10, 0.05.

The OTR can be less than a number that is in a range defined by any two numbers selected from the numbers delineated above, including the end-points of such range.

The relative humidity that can be tolerated by the film construction of the present invention is greater than 70%. Some embodiments of the films of the present invention provide tolerance of the relative humidity % that is greater than the following numbers measured in %:
70, 71, 72, 71, 72, 73, 74, 75, 76, 77, 78, 79, 80, 81, 82, 83, 84, 85, 86, 87, 88, 89, 90, 91, 92, 93, 94, and 95.

The relative humidity % can be more than a number that is in a range defined by any two numbers selected from the numbers delineated above, including the end-points of such range.

### C. Sealant Layer

As used herein, the term “sealant layer” refers to a layer of a laminate of flexible material, wherein the sealant layer is a material that is configured to be sealed to itself or another sealable layer using any kind of sealing method known in the art, including, for example, heat sealing (e.g. conductive sealing, impulse sealing, ultrasonic sealing, etc.), welding, crimping, bonding, and the like, and combinations of any of these.

Exemplary sealant layer comprises low density polyethylene (LDPE), linear low-density polyethylene (LLDPE), and/or LLDPE copolymers.

The sealant layer comprises LDPE. More specifically, the sealant layer comprises LLDPE.

### I. LDPE

By LDPE is meant the low-density polyethylene. Generally, “low-density” refers to the 0.918-0.930 g/cm³ range of polyethylene densities. The LDPE molecules have complex branching patterns, with no easily distinguishable backbone. The polymer molecules are composed of a whole network of branches of various lengths from short to long. The LDPE can be the high-pressure, low-density polyethylene, or HP-LDPE, which is relatively high in average molecular weight, in other words, low in melt-index (0.1-1.1 dg/min).

In one embodiment, the LDPE can be added at up to 30% by weight of the polymer blend of the sealant. Stated differently, the weight percent of LDPE in the polymer blend of the sealant layer can be any one of the following numbers measured in %, or in a range defined by any two numbers provided below, including the endpoints of such range:
0; 1; 2; 3; 4; 5; 6; 7; 8; 9; 10; 11; 12; 13; 14; 15; 16; 17; 18; 19; 20; 21; 22; 23; 24; 25; 26; 27; 28; 29; and 30%.

A preferred range of LDPE weight content is from 10-15% of the polymer blend in the sealant layer. A preferred LDPE is one with an MI between 0.25-1 dg/min and a density of 0.918-0.925 g/cm³. For example, Dow 611A, with a density of 0.924 g/cm³ and an MI of 0.88 is preferred. Also preferred is Dow 132i with an MI of 0.25 and a density of 0.921 g/cm³.

### II. Ethylene-α-Olefin Copolymer (EAO Copolymer)

The EAO copolymer used herein is ethylene-C₄ to C₁₀-α-olefin interpolymer. The ethylene-C₄ to C₁₀-α-olefin interpolymer or EAO copolymer has a melt index of from 0.4 to 1.5 dg/min (g/10 min; 190° C., 2.16 kg); a density of from 0.900 to 0.916 g/cm³ may be a single polymer, or a blend of two polymers, or even several individual polymer grades. Interpolymer encompasses copolymers, terpolymers, and the like.

This EAO copolymer may be selected from linear, low-density polyethylenes (LLDPEs). Using industry convention, linear, low-density polyethylenes in the density range 0.915-0.930 g/cm³ will be referred to as LLDPEs and in the density range of 0.900-0.915 g/cm³ will be referred to as ultra-low-density polyethylenes (ULDPEs) or very low-density polyethylenes (VLDPEs).

Heterogeneously branched ULDPE and LLDPE are well-known among practitioners of the linear polyethylene art. They are prepared using Ziegler-Natta solution, slurry or gas phase polymerization processes and coordination metal catalysts as described, for example, by Anderson, et al. in U.S. Pat. No. 4,076,698, the disclosure of which is incorporated herein by reference. These Ziegler-type linear polyethylenes are not homogeneously branched and they do not have any long-chain branching. At a density less than 0.90 g/cm³, these materials are very difficult to prepare using conventional Ziegler-Natta catalysis and are also very difficult to pelletize. The pellets are tacky and tend to clump together. Companies such as Dow, Nova, and Huntsman can produce suitable interpolymers commercially (tradenames Dowlex™, Sclair™ and Rexell™, respectively) using a solution phase process; ExxonMobil, ChevronPhillips and Nova can produce suitable interpolymers (tradenames NTX™, MarFlex™ LLDPE, Novapol™ LLDPE respectively) by a gas phase process; ChevronPhillips uses a slurry process (MarFlex™ LLDPE). These polymers can be used as a blend component of the inner-ply film layer.

Homogeneously branched ULDPEs and LLDPEs are also well known among practitioners of the linear polyethylene art. See, for example, Elston's U.S. Pat. No. 3,645,992. They can be prepared in solution, slurry or gas phase processes using single site catalyst systems. For example, Ewen, et al., in U.S. Pat. No. 4,937,299, describe a method of preparation using a metallocene version of a single site catalyst. The disclosures of Elston and Ewen are incorporated herein by reference. These polymers are sold commercially by ExxonMobil Chemical under the trademark Exact® and by Dow Chemical under the trademark Affinity® and by Nova Chemical under the trademark Surpass®.

The term “homogeneously-branched” is defined herein to mean that (1) the α-olefin monomer is randomly distributed within a given molecule, (2) substantially all of the interpolymer molecules have the same ethylene-to α-olefin monomer ratio, and (3) the interpolymer has a narrow short chain branching distribution. The short chain branching distribution index (SCBDI) is defined as the weight percent of the polymer molecules having a comonomer content within 50 percent of the median total molar comonomer content. The short chain branching distribution index of polyolefins that are crystallizable from solutions can be determined by well-known temperature rising elution fractionation techniques, such as those described by Wild, et al., Journal of Polymer Science, Poly. Phys. Ed., Vol. 20, p. 441 (1982), L. D. Cady, “The Role of Comonomer Type and Distribution in LLDPE Product Performance,” SPE Regional Technical Conference, Quaker Square Hilton, Akron, Ohio, Oct. 1-2, pp. 107-119 (1985), or U.S. Pat. No. 4,798,081.

Suitable C₄ to C₁₀-α-olefin for inclusion in the linear low-density polyethylenes of the present invention may be 1-octene, 1-hexene, 1-butene, or mixtures thereof, most preferably the α-olefin is 1-octene.

A preferred EAO copolymer is up to 40% butene-LLDPE polymer in the density range of from about 0.818 to about 0.922 g/cm³.

As described above, LLDPE copolymers include LLDPE copolymerized with any one or more of butene, hexene and octene, metallocene LLDPE (mPE) or metallocene plastomers, metallocene elastomers, high density polyethylene (HDPE), rubber modified LDPE, rubber modified LLDPE, acid copolymers, polystyrene, cyclic polyolefins, ethylene vinyl acetate (EVA), ethylene acrylic acid (EAA), ionomers, terpolymers, Barex, polypropylene, bimodal resins, any of which may be from either homopolymers or copolymers, and blends, combinations, laminates, micro-layered, nanolayered, and coextrusions thereof. Polyolefins could be manufactured using Ziegler-Natta catalysts, chromium catalysts, metallocene-based catalysts, single-site catalysts and other types of catalysts. The materials listed could be bio-based, petro-based and recycled/reground].

There is extensive description in the art of the types of polymers, interpolymers, copolymers, terpolymers, etc. that may be used in the sealant layer of the flexible bag of the present invention. Examples of patents that describe such polymers include U.S. Pat. Nos. 4,503,102; 4,521,437; and 5,288,531. These patents describe films used to make pouches, which films may also be used to make bags. Other patents references that describe skin layer polymers include U.S. Pat. Nos. 8,211,533; 8,252,397; 8,563,102; 9,757,926; 9,283,736; and 8,978,346.

In one specific embodiment, the present invention provides a sealant film for use in a film structure for containing flowable materials, the sealant film comprising:
(1) from about 2.0 to about 9.5 wt. %, based on 100 wt. % total composition, of an ethylene C4-C10-alpha-olefin interpolymer having a density of from 0.850 to 0.890 g/cc and a melt index of 0.3 to 5 g/10 min, the interpolymer being present in an amount such that the film structure develops 10 or less pinholes per 300 cm2 in 20,000 cycles of Gelbo Flex testing, as measured using a Gelbo Flex tester set up to test in accordance with ASTM F392, and has a thermal resistance at temperatures just above 100 C, as measured using DSC (ASTM E794/E793) Differential Scanning calorimetry (DSC) which determines temperature and heat flow associated with material transitions as a function of time and temperature, and a minimum tensile modulus of 20,000 psi as measured using Tensile Modulus of the polyethylene films measured in accordance with ASTM Method D882;
(2) from about 70.5 wt. % to about 98.0 wt. %, based on 100 wt. % total composition, of one or more polymers selected from ethylene homopolymers and ethylene C4-C10-alpha-olefin interpolymers, having a density between 0.915 g/cc and 0.935 g/cc and a melt index of 0.2 to 2 g/10 min;
(3) from about 0 wt. % to about 20.0 wt. %, based on 100 wt. % total composition, of processing additives selected from slip agents, anti-block agents, colorants and processing aids; and the sealant film has a thickness of from about 5 to about 60 μm.

In one preferred embodiment, the outer layer of the multi-layer ply comprises ethylene-vinyl alcohol coextrusion; the middle layer comprises metallized biaxial nylon; and the sealant layer comprises LLDPE.

The thickness of the sealant layer is in the range of 25 μm to 100 μm. Stated differently, the thickness of the sealant layer can be any number from the following number in
25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The thickness of the sealant layer can be in the range defined by any two numbers selected from the numbers delineated above, including the end-points of such range.

### D. Other Ingredients

The present blends may include additional ingredients as processing aids, anti-oxidation agents, UV light stabilizers, pigments, fillers, compatibilizers or coupling agents and other additives that do not affect the essential features of the invention. They may be selected from processing masterbatches, colorant masterbatches, at least one low-density ethylene homopolymer, copolymer or interpolymer which is different from component the EAO copolymer of the component (b) of the present blend, at least one polymer selected from the group comprising EVA, EMA, EM, at least one polypropylene homopolymer or polypropylene interpolymer also different from component (b) of the present blend. The processing additives generally referred to, as “masterbatches” comprise special formulations that can be obtained commercially for various processing purposes.

Alternatives to any of these commercially available products would be selectable by a person skilled in the art for the present purposes. The resin blend defined above is selected to ensure that the resulting film has the characteristics defined. Other components, as subsequently described may be added to the blend so long as they do not negatively impact on the desired characteristics of the film of the invention.

### Various Constructions of Invention

### Embodiment 1—Thermal Lamination (Hot Roll) Process

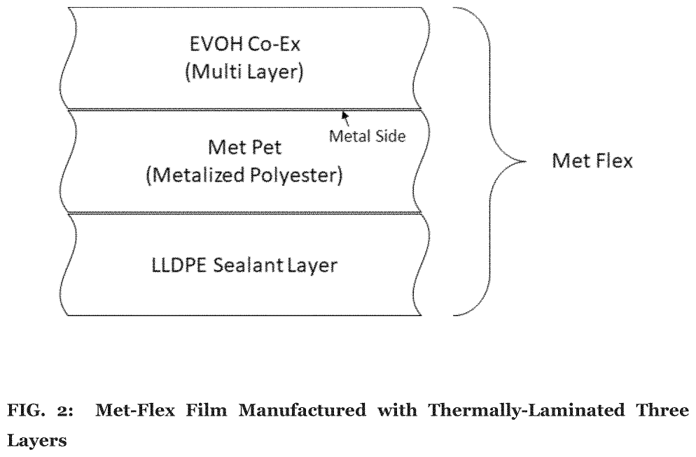

In one embodiment, the invention film comprises 3 layers of flexible film: LLDPE sealant layer; metallized polyester (Met-PET) OTR-reducing barrier layer; and FCR-improving co-extruded EVOH layer. These layers are thermally laminated together to form 1 structure used in the flexible packaging applications. The selection of the raw materials and the placement in their specific order, add value to the material achieving great results in flex-cracking subjected during transportation, and oxygen transmission rate when exposed to high levels of humidity. As shown in FIG. 2, in this embodiment, the Met-Flex construction is manufactured using the Thermal laminatiion, (Hot Roll) process. Typical characteristics are:

First Layer: EVOH Coextruded Blown Film
Layer construction: 3, 5, 7, 9, 12, multi-stream using multiplication layer distribution.
Total thickness is 25-100 micron.

Second Layer: Met-PET
10-15 micron metallized polyester, with an oxygen transmitting rate of 0.1 cm³/m²-day to 2 cm³/m²-day.
Total thickness is 25-100 micron.

### Third Layer: LLDPE—Sealant Layer

Total thickness is 25-100 micron.

Embodiment 2—Extrusion Lamination/Coating

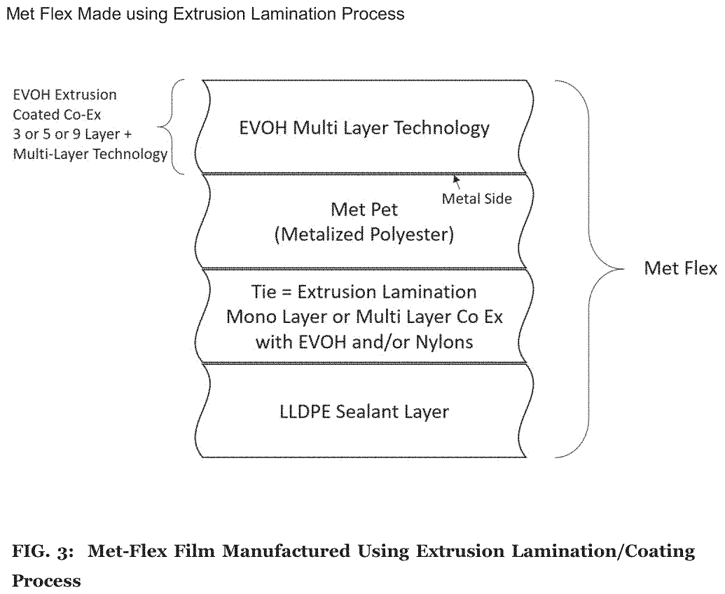

In one embodiment, the invention film comprises 4 layers of flexible film: LLDPE sealant layer; a tie layer; metallized polyester (Met-PET) OTR-reducing barrier layer; and FCR-improving co-extruded EVOH layer. These layers are thermally laminated together to form a structure used in the flexible packaging applications. As shown in FIG. 3, in this embodiment, the Met-Flex construction is manufactured using the Extrusion Laminaton/Coating process. Typical characteristics are:

First Layer: EVOH Extrusion-Coated Coextruded Blown Film
Layer construction: 3, 5, 7, 9, 12, multi-stream using multiplication layer distribution.
Total thickness is 25-100 micron.

Second Layer: Met-PET
10-15 micron metallized polyester, with an oxygen transmitting rate of 0.1 cm³/m²-day to 2 cm³/m²-day.
Total thickness is 25-100 micron.
Metal side is contacts the EVOH layer.

Third Layer: Tie Layer
The tie-layer is made using extrusion lamination, which is a monolayer or a multilayer co-extrusion with EVOH and/or nylon.

Fourth Layer: LLDPE—Sealant Layer
Total thickness is 25-100 micron.

### Embodiment 3—Extrusion Lamination/Co-Extrusion Multi-Layer Technology

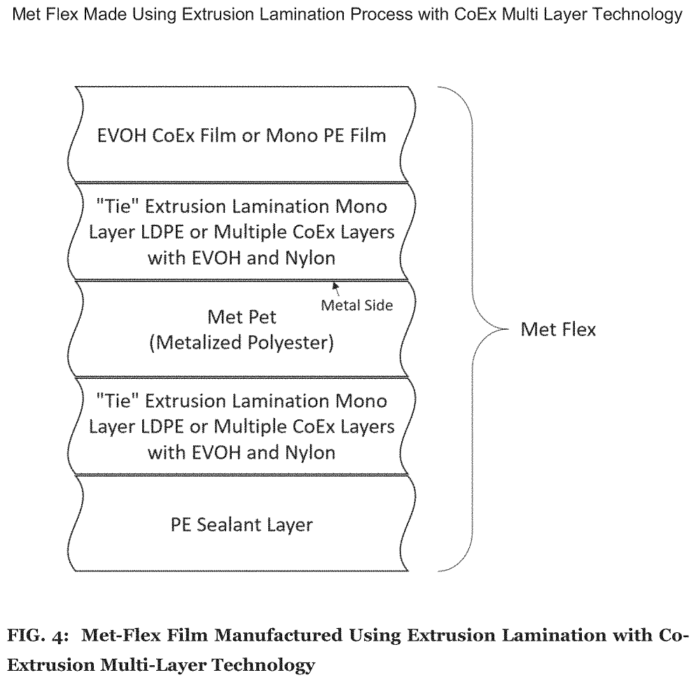

In one embodiment, the invention film comprises 5 layers of flexible film: PE sealant layer; a first tie layer; metallized polyester (Met-PET) OTR-reducing barrier layer; a second tie layer; and FCR-improving co-extruded EVOH layer. These layers are made by extrusion lamination and multi-layer technology to form a structure used in the flexible packaging applications. As shown in FIG. 4, in this embodiment, the Met-Flex construction is manufactured using the Extrusion Laminaton/Co-extrusion Multi-Layer Technology. Typical characteristics are:

First Layer: EVOH Extrusion-Coated Coextruded Blown Film or Monolayer PE Film
Layer construction: 3, 5, 7, 9, 12, multi-stream using multiplication layer distribution.
Total thickness is 25-100 micron.

Second Layer: Tie Layer
The tie-layer is made using extrusion lamination, which is a monolayer LDPE or a multi-layer co-extrusion with EVOH and/or nylon.

Third Layer: Met-PET
10-15 micron metallized polyester, with an oxygen transmitting rate of 0.1 cm³/m²-day to 2 cm³/m²-day.
Total thickness is 25-100 micron.
Metal side contacts the tie layer.

Fourth Layer: Tie Layer
The tie-layer is made using extrusion lamination, which is a monolayer LDPE or a multi-layer co-extrusion with EVOH and/or nylon.

Fifth Layer: LLDPE—Sealant Layer

### Embodiment 4—Extrusion Lamination/Thermal Hot Roll Process

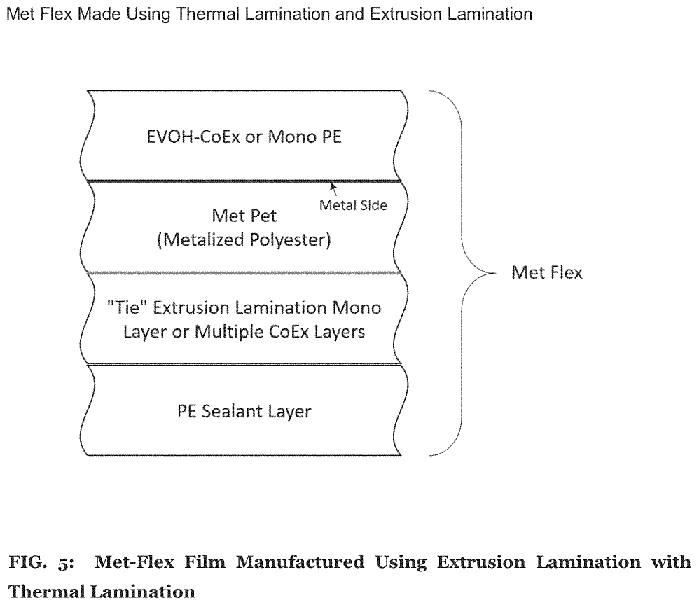

In one embodiment, the invention film comprises 4 layers of flexible film: PE sealant layer; a first tie layer; metallized polyester (Met-PET) OTR-reducing barrier layer; a second tie layer; and FCR-improving co-extruded EVOH layer. These layers are made by extrusion lamination and multi-layer technology to form a structure used in the flexible packaging applications. As shown in FIG. 5, in this embodiment, the Met-Flex construction is manufactured using the Extrusion Laminaton/Hot Roll Thermal Lamination. Typical characteristics are:

First Layer: EVOH Extrusion-Coated Coextruded Blown Film or Monolayer PE Film
Layer construction: 3, 5, 7, 9, 12, multi-stream using multiplication layer distribution.
Total thickness is 25-100 micron.

Second Layer: Met-PET
10-15 micron metallized polyester, with an oxygen transmitting rate of 0.1 cm³/m²-day to 2 cm³/m²-day.
Total thickness is 25-100 micron.
Metal side contacts the tie layer.

Third Layer: Tie Layer
The tie-layer is made using extrusion lamination, which is a monolayer LDPE or a multi-layer co-extrusion with EVOH and/or nylon.

Fourth Layer: LLDPE—Sealant Layer

### Embodiment 5—Adhesive Lamination

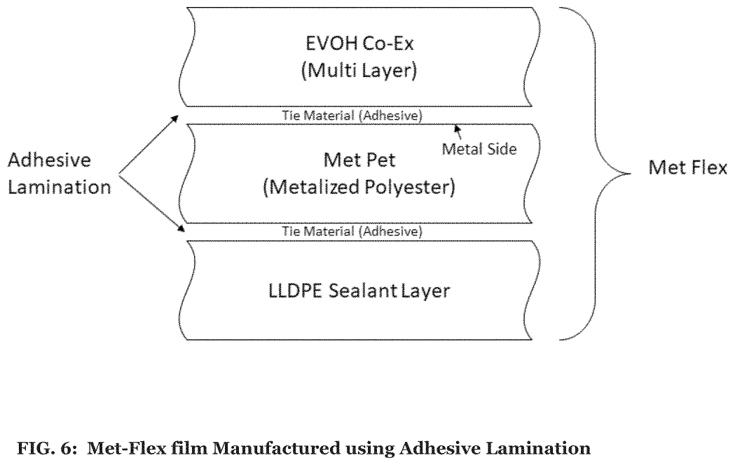

In one embodiment, the invention film comprises 3 layers of flexible film: PE sealant layer; metallized polyester (Met-PET) OTR-reducing barrier layer; and FCR-improving co-extruded EVOH layer. These layers are made by adhesive lamination to form a structure used in the flexible packaging applications. As shown in FIG. 6, in this embodiment, the Met-Flex construction is manufactured using the Extrusion Laminaton/Hot Roll Thermal Lamination. Typical characteristics are:

First Layer: EVOH Extrusion-Coated Coextruded Blown Film or Monolayer PE Film
Layer construction: 3, 5, 7, 9, 12, Multi-stream using multiplication layer distribution.
Total thickness is 25-100 micron.

Second Layer: Met-PET
10-15 micron metallized polyester, with an oxygen transmitting rate of 0.1 cm³/m²-day to 2 cm³/m²-day.
Total thickness is 25-100 micron.
Metal side contacts the tie layer.

Third Layer: LLDPE—Sealant Layer

The three layers adhere to each other using a tie material, an adhesive. A layer with an adhesive with solvent and solventless adhesive can be used.

Alternatives to any of these commercially available products would be selectable by a person skilled in the art for the present purposes. The resin blend defined above is selected to ensure that the resulting film has the characteristics defined. Other components, as subsequently described may be added to the blend as long as they do not negatively impact on the desired characteristics of the film of the invention.

### Other Ingredients

The present blends may include additional ingredients as processing aids, anti-oxidation agents, UV light stabilizers, pigments, fillers, compatibilizers or coupling agents and other additives that do not affect the essential features of the invention. They may be selected from processing masterbatches, colorant masterbatches, at least one low-density ethylene homopolymer, copolymer or interpolymer which is different from component the EAO copolymer of the component (b) of the present blend, at least one polymer selected from the group comprising EVA, EMA, EM, at least one polypropylene homopolymer or polypropylene interpolymer also different from component (b) of the present blend. The processing additives generally referred to, as “masterbatches” comprise special formulations that can be obtained commercially for various processing purposes.

### Bulk-Bags

Other aspects of the invention include bags for containing flowable materials made from the above films.

The bags may be irradiated prior to use in accordance with standard procedures well known in the packaging art.

In multi-layer polymeric film, the layers generally adhere to each other over the entire contact surface, either because the polymer layers inherently stick to each other or because an intermediate layer of a suitable adhesive is used. The bags which may be produced from the films of the invention are pre-made and then usually filled with food through a fitment. They are often sterilized and may be, for example, irradiated in a batch process, employing standard radiation conditions known in the art. The film may also be sterilized rather than the bags. Sterilization can be achieved in a variety of known ways such as by exposure of the film or bag to hydrogen peroxide solution. The films used to make pouches may be similarly treated prior to package formation. Of importance is that the films and bags can endure aseptic packaging condition.

The bags or pouches using the resin blend compositions of the present invention can also be surface treated and then printed by using techniques known in the art, e.g., use of corona treatment before printing.

The capacity of the bags made from the composition of the present invention may vary considerably. Typically, bags can be sized from 1 L to 400 gallons (1 gallon=3.8 L). For example, the bags may range in size given by any number given below in gallons, or within the range defined by any two numbers given below, including the end-points:
0.3, 0.6, 1, 2, 3, 4, 5, 6, 7, 8, 9, 10, 20, 30, 40, 50, 60, 70, 80, 90, 100, 150, 250, 300, 350, 400.

The bags are pre-made and then usually filled through a fitment. They are often radiation sterilized in a batch process by the bag manufacturer. The packaging conditions may include those for aseptic packaging.

### Bag Making

Generally, the invention provides an improved bag-making process comprising the steps of providing a multi-ply film structure, having inner and outer plies, wherein at least one of the plies is a film of the invention, securing a spout to inner and outer plies of the film structure through a hole provided therein, sealing the plies together transversely across the width of the multi-ply film structure, to form a top seal of one bag and a bottom seal of the bag and a top seal of an adjacent bag, then sealing the plies together parallel to the length of the bag line are applied at either side of the films, and trapped air being removed prior to completely sealing the bag, and separating the bags immediately or just prior to use.

Bag-making process is described generally in U.S. Pat. No. 8,211,533, which is incorporated by reference herein.

In one aspect, the present invention relates to providing a film described herein for making a bulk-bag, wherein said film forms the inner-ply of the multi-ply bag.

Bags Filled with Flowable Materials

In one aspect, this invention also relates to bags described above, filled with flowable materials. Examples include bags filled with flowable materials such as water, beverages, juices, coffee, tea, energy drinks, beer, wine, sauces, mustard, ketchup, food dressings, milk, cheese, sour-cream, mayonnaise, salad dressings, relish, oils, soft margarine, coffee concentrate, pastes, puree, ice cream mix, milk shake mix, preserves, emulsions, doughnut fillings, jellies, detergents, caulking materials, medicines, materials used in manufacturing, and the like.

### Experimental

Tests used to characterize and select the resin blends for the films of the present invention are described below.

### A. Flex-Crack Resistance

The Gelbo Flex test was used to determine the flex-crack resistance of film used for preparing flexible bags of the present invention. The test is described below.

### Gelbo Flex Test

This test determines the resistance of flexible packaging materials and films to pinhole failures resulting from flexing. However, it does not measure any abrasion characteristic relating to flex failure. The colored-turpentine portion of the test measures the failures characterized by physical holes completely through the structure.

The Gelbo Flex tester is set up to test in accordance with ASTM F392. This apparatus consists essentially of a 3.5-inch (90 mm)-diameter stationary mandrel and a 3.5-inch movable mandrel spaced at a distance of 7 inches (180 mm) apart from face-to-face at the start position (that is, maximum distance) of the stroke. The sides of the film sample are taped around the circular mandrels so that it forms a hollow cylinder between them. The motion of the moving mandrel is controlled by a grooved shaft, to which the moving mandrel is attached. The shaft is designed to give a twisting motion of 440 degrees, and at the same time, move itself toward the fixed mandrel to crush the film so that the facing mandrels end up 1-inch apart, at their minimum distance. The motion of the machine is reciprocal with a full cycle consisting of the forward and return stroke. The machine operates at 45 cycles per minute.

In this tester, specimens of flexible materials are flexed at standard atmospheric conditions (23° C. and 50% relative humidity), unless otherwise specified. The number of flexing cycles can be varied depending on the flex-crack resistance of the film structure being tested. The flexing action produced by this machine consists of a twisting motion, thus repeatedly twisting and crushing the film. Flex-crack failure is determined by measuring pinholes formed in the film. The pinholes were determined by painting one side of the tested film sample (300 cm² in area) with colored turpentine and allowing it to stain through the holes onto a white backing paper or blotter. Pinhole formation is the standard criterion presented for measuring failure, but other tests such as gas-transmission rates can be used in place of, or in addition to, the pinhole test. The results reported are the average of four repeats.

### EXAMPLE 1

### Gelbo Flex Test

The flex durability of a Met-PET to EVOH film, prepared using extrusion lamination, was tested. The film was specifically developed for the bag-in-box industry to reduce the risk of flex-cracking during handling or transport. Flex durability tests were conducted using the FDT-01 Flex Durability Tester (Gelbo) under the ASTM F392-93 (R04) standard.

The samples for the Gelbo Flex Test were prepared using a 280 mm×200 mm template. All samples were cut using the same template and under the same conditions.

Four 280 mm×200 mm samples were attached to the mandrels using double-sided tape, 10-12 mm wide. The test parameters were then selected to start the test and were stopped once the cycles were completed. One cycle turned 440° with a horizontal stroke of 155 mm. Twist frequency on this machine equaled 45 cycles/min. Two intervals were selected: 50 cycles and 100 cycles.

After the Gelbo Flex testing, the same sample films were used for measuring their oxygen transmission.

### B. Oxygen Transmission Rate Reduction

The OTR test determined the reduction in oxygen transmission in the film used for preparing flexible bags of the present invention. The test is described below.

### Mocon-Oxtran D3985 Test

A suitably sized sample of film was cut on the cutting mat using the MOCON template for the Mocon Oxtran machine. The cut sample film was then positioned into the Mocon Oxtran and clamped into position as per the specific machine requirements. The machine was set up to the ASTM D3985 standard.

The parameter settings are based on industry standard tests with only incremental adjustment for Relative Humidity set point for each test performed. The test temperature was set to 23° C. and the gases used for this Mocon Oxtran 2/20 machine were nitrogen, hydrogen, and oxygen at 50% RH.

The sample was tested until the graph showed a plateau, and test times varied from 8 hours to 70 hours depending on the graph curve. All results were captured in units of cm3/100 in2-day. The data were gathered using 6 different samples for each film, that of the invention as well as the commercially available comparative films. The machine was set at a relative humidity, namely: 60 RH%; 70 RH%; 80 RH%; 90 RH%; and 95 RH%. An average OTR of the six samples was reported for each RH% measurement for each commercial sample as well as the invention sample.

### EXAMPLE 1

### OTR Measurement

One sample was tested before Gelbo testing to establish the benchmark. Thereafter, OTR of samples was tested after 50 and 100 cycles in the Mocon-Oxtran machine to establish the deterioration of the barrier during flex-crack testing.

The OTR test was performed on five samples:

1. First commercial sample

2. First commercial sample

3. First commercial sample

4. First commercial sample

5. Invention Sample: Met-Flex

TABLE 1
OTR Measurement using OXTRAN ® Model 1/50

| | | OTR after 50 | OTR after 100 |
|---|---|---|---|
| | OTR Before | Cycles of | Cycles of |
| | Gelbo Flex Test | Gelbo Flex Test | Gelbo Flex Test |
| Material Type | cm³/m²-day | cm³/m²-day | cm³/m²-day |
| MET-FLEX | 0.327 | 0.863 | 1.026 |
| Invention | | | |
| Sample | | | |

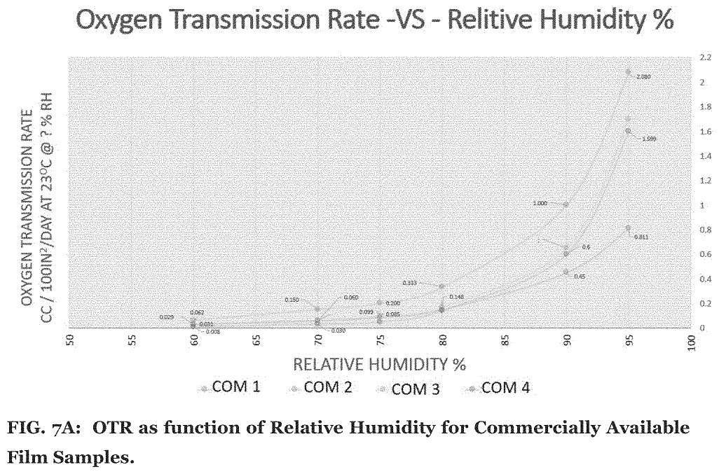

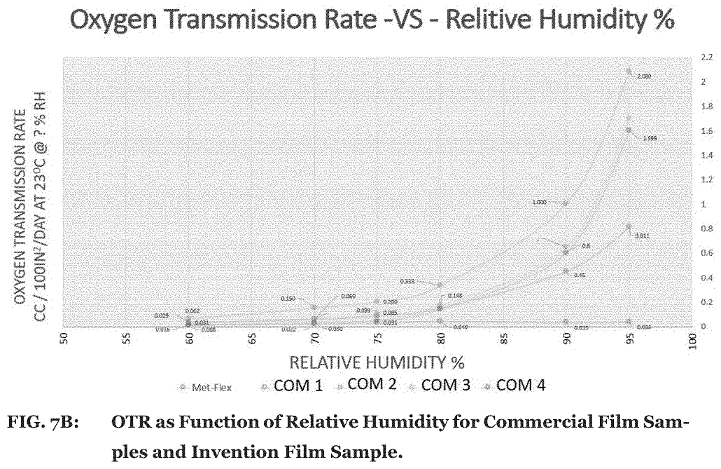

In FIG. 7A and 7B are shown graphs that depict the OTR of various samples—commercial and invention—at varying % RH as measured in the Mocon-Oxtran test. With the intention of being able to store wine or spirits in a flexible packaging format for a longer period currently prescribed by the market, 9-12 months, a method was needed to reduce oxygen ingress through the packaging after the filling process had taken place. Also needed was a method to reduce the effect of dissolved oxygen in the wine, during normal transport, distribution, storage, and display. With current available material structures being exposed to a varying relative humidity during transport, distribution, storage, and display, the effect of the OTR rate of the current packaging materials available in this segment are compromised.

The graph in FIG. 7A depicts the OTR versus RH for typical film materials used in bag-in-box application for wine and food segment. The materials were tested for OTR at different RH, from 50% to 95%. The graph in FIG. 7B also includes the film lamination of the present invention, Met-Flex.

For commercial samples, the oxygen transmitting rate got worse with an increase in the relative humidity. However, as the humidity increased for the invention sample, surprisingly, the oxygen transmitting rate remained unchanged, which, according to one theory—while the inventors are not wishing to be bound by this or any other theory—directly affects the amount of dissolved SO₂ in the wine, allowing it to stay fresher for longer. Clearly, the effect of increasing the relative humidity had little to NO effect on the oxygen transmission rate of the invention sample. (See horizontal blue line at bottom.) In summary, the amount of oxygen that could pass through the lamination of the present invention was now limited and did NOT increase with an increase in relative humidity.

What is claimed:

1. A polymeric film for preparing flexible bags, comprising the following layers:
(A) a sealant layer, wherein said sealant layer comprises LLDPE;
(B) an OTR-reducing barrier layer, wherein said OTR-reducing barrier layer comprises metallized PET or metallized BoPA; and
(C) an FCR-improving layer, wherein said FCR-improving layer comprises EVOH co-ex;
wherein said polymeric film demonstrates an oxygen transmission rate (OTR) not greater than 1 cm³/m²-day after 50 cycles of Gelbo Flex test.

2. The polymeric film as recited in claim 1, wherein said flexible bag demonstrates an oxygen transmission rate (OTR) not greater than 1.5 cm³/m²-day after 100 cycles of Gelbo Flex test.

3. The polymeric film as recited in claim 1, wherein said sealant layer, said OTR-reducing barrier layer, and said FCR-improving layer each have a thickness in the range of from about 25 microns to 100 microns.

4. The polymeric film as recited in claim 1, made using at least one of the following processes:
extrusion lamination, thermal lamination, with-solvent adhesion, solventless adhesion, coating, and co-extrusion multi-layer technology.

5. A flexible bag prepared from a polymeric film, wherein said polymeric film comprises the following layers:
(A) a sealant layer, wherein said sealant layer comprises LLDPE;
(B) an OTR-reducing barrier layer, wherein said OTR-reducing barrier layer comprises metallized PET or metallized BoPA; and
(C) an FCR-improving layer, wherein said FCR-improving layer comprises EVOH co-ex;
wherein said polymeric film demonstrates an oxygen transmission rate (OTR) not greater than 1 cm³/m²-day after 50 cycles of Gelbo Flex test.

6. The flexible bag as recited in claim 5, wherein said flexible bag demonstrates an oxygen transmission rate (OTR) not greater than 1.5 cm³/m²-day after 100 cycles of Gelbo Flex test.

7. The flexible bag as recited in claim 5, wherein said sealant layer, said OTR-reducing barrier layer, and said FCR-improving layer each have a thickness in the range of from about 25 microns to 100 microns.

8. The flexible bag as recited in claim 5, made using at least one of the following processes:
extrusion lamination, thermal lamination, with-solvent adhesion, solventless adhesion, coating, and co-extrusion multi-layer technology.

9. The flexible bag, as recited in claim 5, wherein said bag has a capacity from about 1 L to 400 gallons.

10. A packaged flexible bag, comprising one of the following products:
(A) wine, (B) beer, (C) water, (D) milk, (E) a non-alcoholic beverage, (F) an alcoholic beverage not including wine or beer, (G) aerated water, (H) an energy drink, (I) fruit juice, (J) vegetable juice, (K) chemical, and (L) detergent; (M) juice not including fruit juice; (N) sauces; (O) mustard; (P) ketchup; (Q) food dressings; (R) cheese; (S) sour-cream; (T) mayonnaise; (U) salad dressings; (V) relish; (W) oil; (X) margarine; (Y) coffee concentrate; (Z) pastes; (Z1) puree; (Z2) ice cream mix(Z3) milk shake mix; (Z4) preserves; (Z5) emulsions; (Z6) doughnut fillings; (Z7) jellies; (Z8) caulking material; (Z9) medicine; and (Z10) materials used in manufacturing;
wherein, said flexible bag demonstrates an oxygen transmission rate (OTR) not greater than 0.6 cm³/m²-day.

11. The packaged flexible bag as recited in claim 10, wherein said flexible bag is exposed to a relative humidity of at least 75% RH.

12. The packaged flexible bag as recited in claim 11, wherein said relative humidity is selected from at least 75% RH, at least 80% RH, at least 85% RH, at least 95% RH, and at least 95% RH.

13. The packaged flexible bag as recited in claim 11, wherein said flexible bag demonstrates an oxygen transmission rate (OTR) not greater than 1 cm³/m²-day after 50 cycles of Gelbo Flex test.

14. The packaged flexible bag as recited in claim 11, wherein said flexible bag demonstrates an oxygen transmission rate (OTR) not greater than 1.5 cm³/m²-day after 100 cycles of Gelbo Flex test.

15. The packaged flexible bag as recited in claim 11, wherein said product is wine.

16. The packaged flexible bag as recited in claim 11, wherein said product is beer.

17. The packaged flexible bag as recited in claim 11, wherein said product is water.

18. The packaged flexible bag as recited in claim 11, wherein the film of said flexible bag comprises the following layers:
(A) a sealant layer, wherein said sealant layer comprises LLDPE;
(B) an OTR-reducing barrier layer, wherein said OTR-reducing barrier layer comprises metallized PET or metallized BoPA; and
(C) an FCR-improving layer, wherein said FCR-improving layer comprises EVOH co-ex.

19. The packaged flexible bag as recited in claims 18, wherein said sealant layer, said OTR-reducing barrier layer, and said FCR-improving layer each have a thickness in the range of from about 25 microns to 100 microns.

20. The packaged flexible bag as recited in claim 11, wherein said film for said flexible bag is made using at least one of the following processes:
extrusion lamination, thermal lamination, with-solvent adhesion, solventless adhesion, coating, and co-extrusion multi-layer technology.

21. The packaged flexible bag, as recited in claim 8, wherein said bag has a capacity from about 1 L to 400 gallons.
